(19) United States
(12) Patent Application Publication
(10) Pub. No.: US 2008/0179314 A1
(43) Pub. Date: Jul. 31, 2008

(54) Positive Temperature Heating Element with Heat Sinks

(75) Inventors: Renato Colja, Windsor (CA); Jianlin Zhang, Windsor (CA); Corina Simona Alionte, Windsor (CA)

Correspondence Address: KANG INTELLECTUAL PROPERTY LAW, LLC, 214 ELM STREET, SUITE 106, WASHINGTON, MO, 63090, US

(73) Assignee: SCHUKRA OF NORTH AMERICA, LTD., Tecumseh (CA)

(21) Appl. No.: 11/940,791

(22) Filed: Nov. 15, 2007

Related U.S. Application Data
(60) Provisional application No. 60/867,052, filed on Nov. 22, 2006.

(51) Int. Cl. H05B 3/10; B60L 1/02

(52) U.S. Cl. 219/548; 219/202

(57) ABSTRACT

The invention is a novel heating unit utilizing a positive temperature coefficient (PTC) heater, and fixing the PTC heater between two heat sinks. The new heater is placed in the blower output, and negates the need for a separate heater layer under the trim of an automotive seat.

### CROSS-REFERENCE TO RELATED APPLICATIONS

This application claims priority to U.S. Provisional Patent Application No. 60/867052 filed Nov. 22, 2006.

### STATEMENT REGARDING FEDERALLY SPONSORED RESEARCH

Not applicable.

### APPENDIX

Not applicable.

### BACKGROUND OF THE INVENTION

1. Field of the Invention

The present invention relates to a solid state temperature regulation system. More specifically, this invention is a new compact unit for heating an automotive seat using a positive temperature coefficient heater.

2. Related Art

Currently, automotive seats are heated using a heater layer. This heater layer is provided with a resistive wire pattern which emits heat when powered. This heater layer is mounted under a trim cover in an automotive seat. This heater layer is separate and independent from other thermoelectric devices (TED), which are commonly referred to as Peltier devices, and heat sinks used in heating and cooling applications. The present heater layer has the disadvantages of providing two much heat, requiring more parts (and thus expense), a larger overall package size, and increased costs due to additional assembly requirements.

### SUMMARY OF THE INVENTION

The invention is a novel heater. The heater uses a different class of heater referred to as a positive temperature coefficient (PTC) heater. The present invention couples a PTC heater with multiple heat sinks. When air is blown over the unit, a very effective heating generation and delivery system results.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan side view of the heater of the present invention;

FIG. 2 is an elevated side view of the heater of the present invention; and

FIG. 3 is a plan front view of the heater of the present invention.

### DETAILED DESCRIPTION OF THE PREFERRED EMBODIMENTS

The following description of the preferred embodiment(s) is merely exemplary in nature and is in no way intended to limit the invention, its application, or uses.

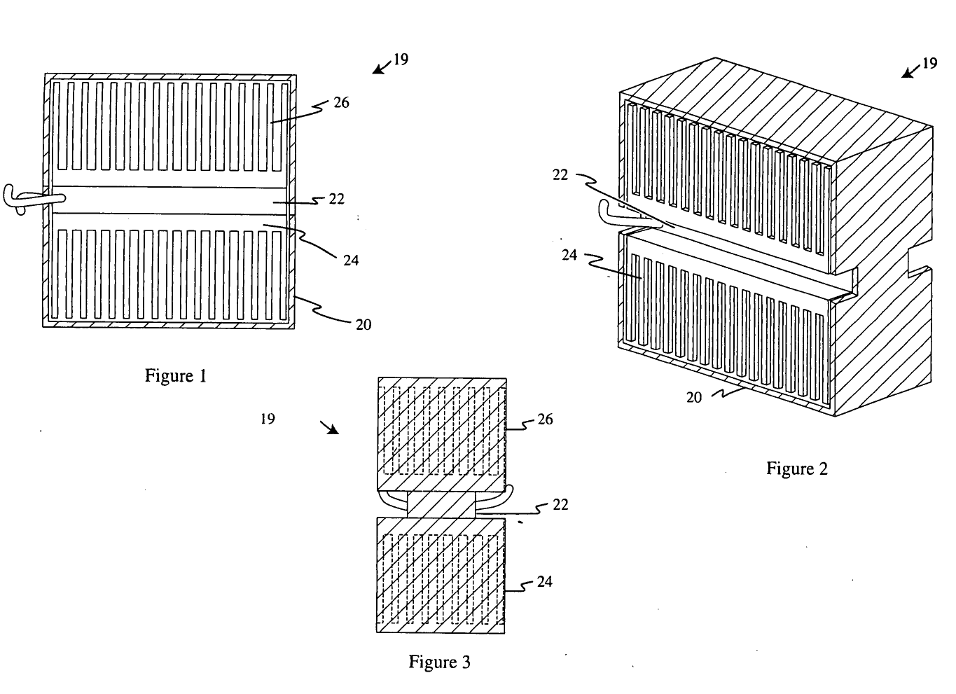

An outer housing 20 is made preferably from closed cell foam. As seen in FIGS. 1-3, a PTC (positive temperature coefficient) heater 22 is disposed in the center of the housing 20. First and second heat sinks, 24 and 26, respectively, are disposed on each side, respectively, of the PTC heater 22. The PTC heater 22 may be joined with each heat sink, 24, 26, by soldering, clamping, epoxy or gluing. If solder is used, the melting temperature of the solder should be higher than the maximum operating temperature of the PTC heater 24, 26. If clamping is used to join the PTC heater 22 to the heat sinks, 24, 26, thermal grease or thermal compound should be used to ensure good heat transfer. If epoxy or glue is used, an epoxy or glue having a high thermal conductivity should be used.

The novel heating unit 19 is then placed in close proximity to a blower output (not shown). It is preferred that the unit 19 is placed in the housing of the output of the blower (not shown). Once activated, the PTC heater 22 generates heat very efficiently, and the heat is absorbed by first heat sink 24 and second heat sink 26. The first heat sink 24 and second heat sink 26 allow a greater surface area and heat capacity over a conventional PTC heater 22 that does not have any heat sink. Airflow from the blower output (not shown) over the heating unit 19 transports heat by convection heat transfer. The novel combination of heats sinks, 24 and 26, and the PTC heater 22 eliminates the need to provide a separate heating layer or pad under the seat trim of an automotive seat. Eliminating the separate heating layer significantly reduces cost by eliminating not only the costly heating layer, but also the eliminating seat trim assembly. By eliminating the need for a separate heating layer, there is also some weight savings; the PTC heater 22 is self-regulating and so will not overheat the passenger, unlike a conventional heating layer under the seat trim.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A heater comprising:
a housing;
a positive temperature coefficient heater having a first side and a second side;
a first heat sink disposed on said first side of said PTC element; and
a second heat sink disposed on said second side of said PTC element.

2. A heater according to claim 1, further comprising:
a blower having an output, wherein said heater is disposed in said output of said blower.

3. A heater according to claim 1, wherein said positive temperature coefficient heater is joined to said first heat sink and said second heat sink by one or more of the following means: soldering, clamping, epoxy and gluing,
